(19) United States
(12) Patent Application Publication
(10) Pub. No.: US 2013/0272609 A1
(43) Pub. Date: Oct. 17, 2013

(54) SCENE SEGMENTATION USING PRE-CAPTURE IMAGE MOTION

(71) Applicants: Wei Sun, San Jose, CA (US); Kieran Del Pasqua, Portland, OR (US); Horst Haussecker, Palo Alto, CA (US)

(72) Inventors: Wei Sun, San Jose, CA (US); Kieran Del Pasqua, Portland, OR (US); Horst Haussecker, Palo Alto, CA (US)

(73) Assignee: Intel Corporation, Santa Clara, CA (US)

(21) Appl. No.: 13/977,185

(22) PCT Filed: Dec. 12, 2011
(86) PCT No.: PCT/US11/64321

§ 371 Date: Jun. 28, 2013

(51) Int. Cl. G06T 7/00

(52) U.S. Cl. CPC G06T 7/0079
USPC 382/173

(57) ABSTRACT

Systems, devices and methods are described including using object motion appearing in pre-capture images to perform 3D reconstruction of a scene. Objects may be segmented and tracked within the pre-capture images using image processing techniques such as image segmentation and/or object recognition. The image processing results may then be used to automatically tag subsequently captured images. Further, the image processing results may also be used to interactively control an imaging device's focusing mechanism prior to image capture.

### BACKGROUND

Image segmentation, which is the process of separating objects from each other and from the background of a scene in a still image, is important to many applications, including automatic image tagging, content based image retrieval, object recognition, and so forth.

There are two general approaches employed in image segmentation. In two-dimensional (2D) approaches, a typical color camera may be used to capture a 2D still image of a three-dimensional (3D) scene and image segmentation may then be performed based largely on color information in the still image. However, because certain aspects of a scene's information, such as the depth of various objects within the scene, is lost after a 2D image is captured, and because different objects and/or the background in a scene may have similar colors, such color-based 2D image segmentation is an ill-posed problem and often may not be solved with sufficient quality.

In 3D approaches, a stereo camera pair or a color-depth camera (e.g., a structured light camera or a time-of-flight camera) may be used to capture not only color but also depth information. Image segmentation may then be performed based on the depth information with or without use of the color information. These depth-based approaches are often more reliable than color-based methods as they utilize the underlying geometry of the scene. Unfortunately, depth-based image segmentation typically requires special hardware, such as a calibrated and synchronized camera pair or cameras equipped with depth sensing technology, and, hence, is not applicable to ordinary (non-depth capable) consumer cameras such as camera equipped mobile devices.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 is a flow diagram illustrating an example automatic image tagging process;

FIGS. 3 and 4 are illustrative diagrams of example pre-capture image schemes;

FIG. 5 is a flow diagram illustrating an example object tracking process;

FIG. 6 is a flow diagram illustrating an example interactive focus control process;

FIG. 7 is an illustrative diagram of an example interactive focus control scheme;

FIG. 8 is an illustrative diagram of an example system; and

FIG. 9 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein arc not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc, claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof The material disclosed herein ma also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

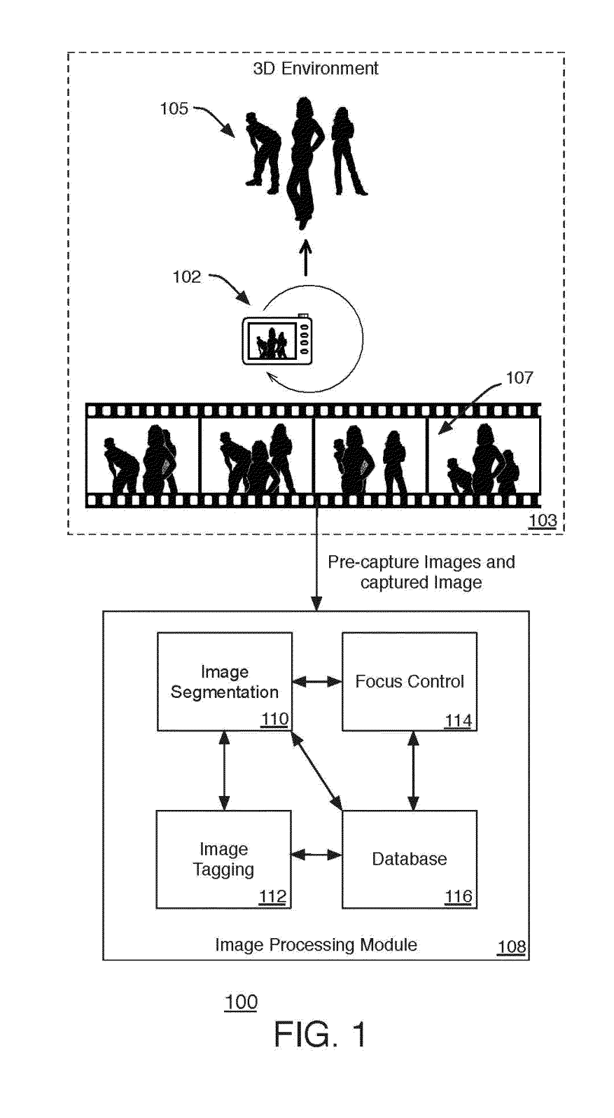

FIG. 1 illustrates an example system 100 in accordance with the present disclosure. In various implementations, system 100 may include an imaging device 102, such as a video capable camera, configured to generate pre-capture images 107 in the form of a series of two-dimensional (2D) images of a three-dimensional (3D) scene 105, where images 107 of scene 105 have been obtained while imaging device 102 is in motion with respect to scene 105 (e.g., circular motion as shown). As used herein, the term “pre-capture image” may refer to an image obtained by imaging device 102 prior to a user operating a shutter mechanism (not shown) on device 102 to specifically capture one or more images such as still or video images.

In accordance with the present disclosure, a user of imaging device 102 may aim device 102 at scene 105, and, prior to the user activating a shutter mechanism on device 102, pre-capture images 107 may be obtained and subjected to various types of image processing as will be described in greater detail below. For instance, a user of device 102 may partially engage a shutter mechanism or otherwise place device 102 into a predetermined imaging mode prior to the user fully engaging the shutter mechanism or otherwise initiating the capture of one or more images, the user may then move imaging device 102 relative to 3D scene 105 so that pre-capture images 107 may include different perspectives relative to scene 105. In various implementations, a shutter mechanism of device 102 may be a hardware mechanism, a software mechanism, or any combination thereof. For example, a user interface, such as a graphical user interface (GUI) provided by device 102 may permit a user to initiate an imaging mode that uses device 102 to obtain pre-capture images 107. In some implementations, an imaging mode application may use a GUI to prompt the user to move device 102 relative to scene 105 when obtaining pre-capture images 107.

System 100 also includes an image processing module 108 in accordance with the present disclosure that may receive pre-capture images 107 and may perform image segmentation on the pre-capture images as will be described in greater detail below. Image processing module 108 may also receive one or more, captured images that have been generated when a user activates a shutter of imaging device 102. Image processing module 108 may then use object information resulting from image segmentation of the pre-capture images to perform object recognition on the captured image.

In various implementations, image processing module 108 includes an image segmentation module 110, an image tagging module 112, a focus control module 114, and a database 116. In accordance with the present disclosure, image segmentation module 110 may undertake image segmentation processing of pre-capture images 107 to extract depth information from the scene and to segment one or more objects (such as people) in the pre-capture images 107. Image segmentation module 119 may then track those objects within pre-capture images 107 using an object tracking algorithm as will be explained in greater detail below.

To segment objects, image segmentation module 110 may se known image segmentation techniques to locate objects in pre-capture images 107. To do so, image segmentation module 110 may segment each pre-capture image into various regions (segments) where pixels in each segment have a similar characteristic or property such as color, intensity or texture. Motion of the identified segments between pre-capture image frames may then be used to perform a 3D reconstruction of scene 105. When undertaking image segmentation, module 110 may use various known techniques such as clustering, compression-based, histogram-based, edge detection, region growing, split-and-merge, graph partitioning, model based, multi-scale, and/or neural network techniques and the like (see, e.g., Newcombe and Davison, “Live Dense Reconstruction with a Single Moving Camera”, IEEE Conference on Computer Vision and Pattern Recognition (2010)).

Image segmentation module 110 may also employ known motion estimation techniques such as optical flow techniques to track segmented objects and perform 3D reconstruction within pre-capture images 107 (see, e.g., Brooks, et al., “3D reconstruction from optical flow generated by an uncalibrated camera undergoing unknown motion”, International Workshop on Image Analysis and Information Fusion, Adelaide, pp. 35-42 (1997)). Further, when undertaking object tracking, module 110 may employ an object tracking algorithm in accordance with the present disclosure as will be described in greater detail below.

Upon performing image segmentation, image segmentation module 110 may generate object information and may provide that information to image tagging module 112, focus control module 114, and/or database 116. For example, object information provided by image segmentation module 110 may include object results as, but not limited to, object masks corresponding to segmented objects.

In various implementations, image tagging module 112 may receive object results from image segmentation module 110 and/or database 116 and, as will be explained in greater detail below, image tagging module 112 may use the object results to automatically tag otherwise label objects appearing in a captured image of scene 105. In various implementations, image tagging module 112 may tag a captured image with object by, for example, labeling an object as being a particular person or item. To do so, module 112 may use known object recognition techniques (see, e.g., Viola and Jones, “Rapid Object Detection using a Boosted Cascade of Simple Features”, IEEE Conference on Computer Vision and Pattern Recognition (2001)) and/or known facial recognition techniques (see, e.g., V. Blanz, T. Vetter, “Face Recognition Based on Fitting a 3D Morphable Model,” IEEE Transactions on Pattern Analysis and Machine Intelligence, Vol. No. 9, September 2003, pp. 1063-1074) to recognize one or more people and/or items appearing in the captured image. In various implementations, known facial recognition techniques that may be employed by module 112 include Principal Component Analysis (PCA), Independent Component Analysis (ICA), 3D morphable models (as noted above), Linear Discriminate Analysis (LDA). Elastic Bunch Graph Matching (EBGM), Hidden Markov Model (HMM), and neuronal motivated dynamic link matching, to name some non-limiting examples. Image tagging module 112 may then store corresponding object metadata in database 116 in association with the captured image or images.

In various implementations, focus control module 114 may also receive object information from image segmentation module 110 and/or database 116. As will be explained in greater detail below, focus control module 114 may use the object information to provide interactive control of a focusing mechanism of imaging device 102. For example, a GUI provided by imaging device 102 may permit a user to initiate, an interactive focusing application that employs focus control module 114 and that permits the user to interactively control a focusing mechanism of imaging device 102 as will be explained in greater detail below.

Database 116 may be any type of organized collection of data including, but not limited to, object, information, image metadata and/or associated images, and so forth. For instance, database 116 may be any type of organized collection of data and may refer to a logical database, or to a physical database of data content in computer data storage (e.g., stored in memory, stored on hard drive(s) and so forth). In some implementations, database 116 may include a database management system (not shown). In some implementations, database 116 may be provided by one or more memory devices (e.g., random access memory (RAM), etc.) and a file and/or memory management system (not shown) may provide image segmentation module 110, image tagging module 112, and focus control module 114 with access to database 116 for the purposes of reading and/or writing data, such as object masks, from and/or to database 116.

In various implementations, imaging device 102 may be any type of device, such as a video capable smart phone or the like, capable of providing pre-capture images 107 in digital form to image processing module 108. In addition, pre-capture images 107 may have any resolution and. or aspect ratio For example, rather than store and process pre-capture images 107 in full resolution, each pre-capture image may be downscaled to a lower resolution format prior to image processing as described herein.

Further, while FIG. 1 depicts, image processing module 108 as being separate from imaging device 102, those of skill in the art will recognize that image processing module 108 may be a component of imaging device 102 although the present disclosure is not limited in this regard. For example, in various implementations, image processing module 108 may be physically remote from imaging device 102. For instance although not depicted in FIG. 1 in the interest of clarity, a local area network (LAN) and/or a wide area network (WAN) may communicatively couple image processing module 108 with imaging device 102.

In addition, in various implementations, image processing module 108 may be provided by any combination of hardware, firmware and/or software. For example, image processing module 108 may be provided, at least in part, by software executing on one or more processor cores that may be internal to imaging device 102, or that may be remote to image device 102 (e.g., distributed across one or more server systems remote to imaging device 102 and so forth). Further, image processing module 108 may include various additional components that have not been depicted in FIG. 1 in the interest of clarity. For example, image processing module 108 may also include various communications and/or data buses, interconnects, interface modules, and the like.

### Automatic Image Tagging

In various implementations, an imaging device in accordance with the present disclosure may use object information to automatically tag captured images. When objects, such as people, appearing in a captured image have already been segmented using pre-capture images, they may be labeled in the captured image based on object recognition and/or facial recognition techniques. The labeling results may then be used to automatically tag the image with metadata specifying the object labels (e.g., person A, person B, automobile, etc.).

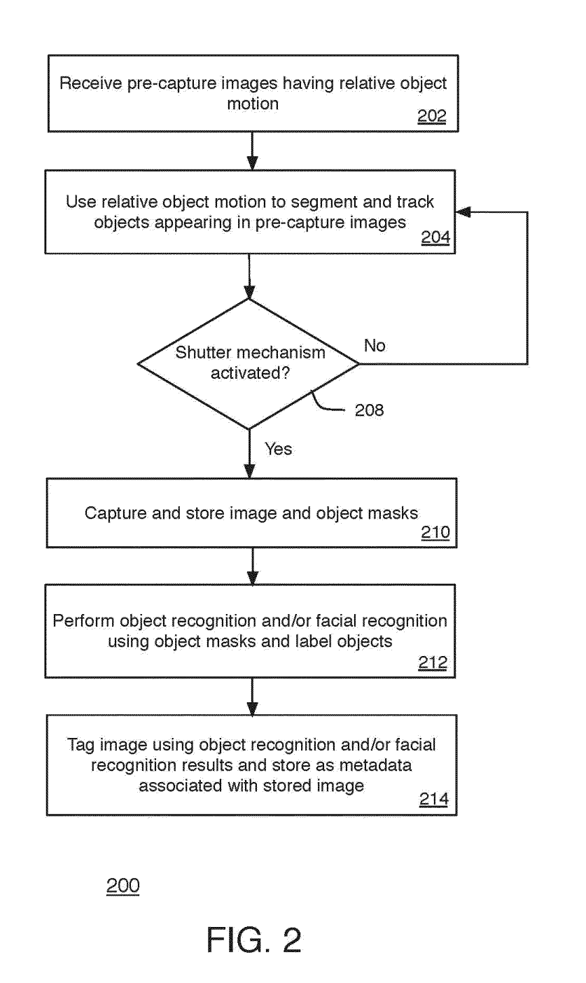

FIG. 2 illustrates a flow diagram of an example process 200 for automatic image tagging according to various implementations of the present disclosure. Process 200 may include one or more operations, functions or actions as illustrated by one or more of blocks 202, 204, 208, 210, 212 and 214 of FIG. 2. By way of non-limiting example, process 200 will be described herein with reference to image processing module 108 of example system 100 of FIG. 1.

Process 200 may begin at block 202 where pre-capture images may be received. At block 204 relative motion between objects in the pre-capture images may be used to segment and track those objects. For example, pre-capture images 107 may be received by image processing module 108 at block 202, and image processing module 108 may employ image segmentation module 110 to undertake block 204 using the known techniques referred to above.

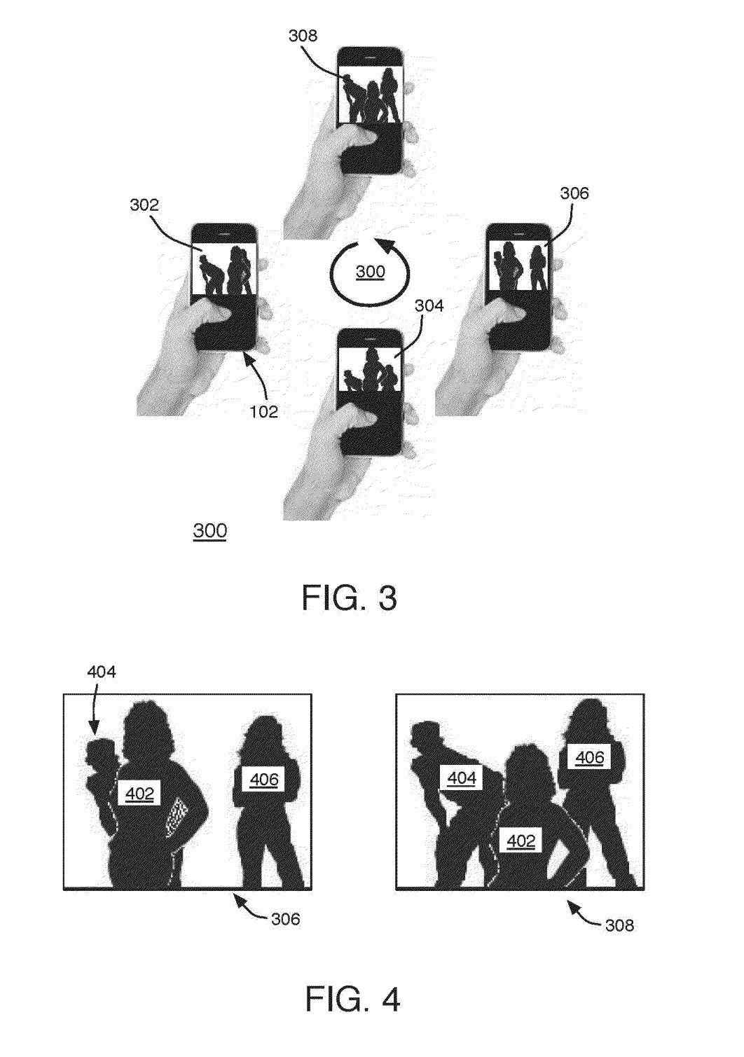

FIG. 3 illustrates example pre-capture images 302, 304, 306 and 308 as may be obtained by imaging device 102 (e.g., a camera equipped mobile device) when undertaking a roughly circular motion 300 with respect to scene 105. As described previously, in various implementations, a user of device 102 may be prompted by a GUI (not shown) to undertake motion 300. As noted previously, the present disclosure is not limited to the particular motions described herein such as circular motion 300 and any type, trajectories or extent of motions sufficient to obtain pre-capture images having relative object motion are contemplated by the present disclosure. For instance, approximately oval, round, elliptical, and/or linear motion may be employed to name a few non-limiting examples. Thus, in some implementations, before engaging the shutter mechanism a user may obtain pre-capture images 107 by moving imaging device 102 gently up and down or left and right while stilt pointing device 102 at scene 105.

As noted above, block 204 may be undertaken by image segmentation module 110 using known image segmentation techniques such as optical flow techniques. For example, in various implementations, image segmentation module 110 may employ optical flow techniques to perform motion estimation in pre-capture images using either instantaneous image velocities or discrete image displacements by determining the motion between two image frames obtained at times (t) and (t+δt) at every voxel position. To do so, image segmentation module 110 may, to name a few non-limiting examples, employ phase correlation, block-based, differential, or discrete optimization techniques to identify motion vectors describing relative object motion in the pre-capture images. In some implementations, object tracking may be applied to every n pre-capture image frames using a sliding window to propagate the segmentation results temporally.

For instance, FIG. 4 illustrates example pre-capture images 306 and 308 where objects appearing in the pre-capture images may be segmented and tracked by image segmentation module 110 when undertaking block 204. For instance, image segmentation module 110 may segment objects 402, 404 and 406 and then track the motion of these objects in the pre-capture images. Further, as a result of undertaking image segmentation at block 204, image segmentation module 110 may generate object masks corresponding to the various segmented objects. For instance, in the example of FIG. 4, image segmentation module 110 may generate a separate object mask for each of segmented objects 402, 404 and 406.

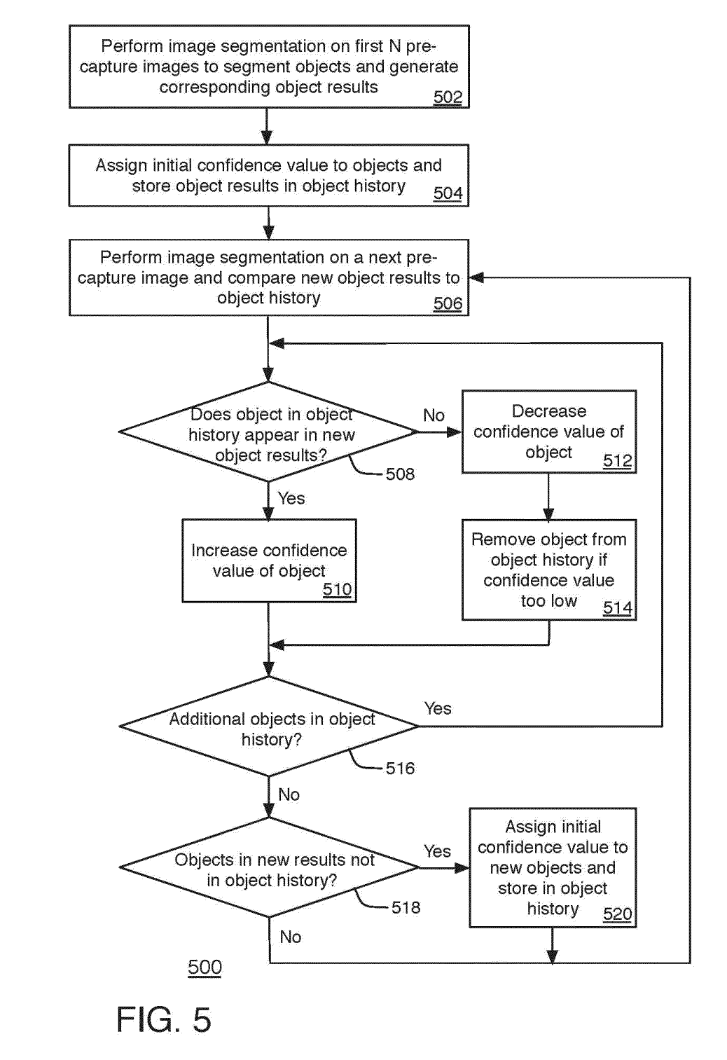

In various implementations, implementation of blocks 202 and 204 may happen at least partially concurrently and image segmentation module 110 may continue to segment and track objects in the pre-capture images until a determination is made that a user of the imaging device has operated a shutter mechanism to capture an image (block 208). For example. FIG. 5 illustrates an example object tracking process 500 in accordance with present disclosure that may be employed when undertaking block 204 of process 200. Process 500 may include one or more operations, functions or actions as illustrated by one or more of blocks 502, 504, 506, 508, 510, 512, 514, 516, 518 and 520 of FIG. 5. By way of non-limiting example, process 500 will be described herein with reference to image processing module 108 of example system 100 of FIG. 1.

Process 500 may begin at block 502 where image segmentation may be performed on a first number (N) of pre-capture images to segment objects and generate corresponding object results. In various implementations, the number N may range from one to any integer number that is greater than one, although the present disclosure is not limited to a particular number of pre-capture images processed at block 502. Initial confidence values may then be assigned to the segmented objects and the object results may be stored. as an object history (block 504). For example, blocks 502 and 504 may be undertaken by image segmentation module 110 on one or more of pre-capture images 107 and may result in the generation of object masks and the storage of those object masks in an object history.

At block 506 image segmentation may be performed on a next pre-capture image frame and the new object results obtained for that next pre-capture image may be compared to the object history obtained from the previous N pre-capture images. In various implementations, block 506 may involve comparing object masts associated with objects contained in the new object results to object masks associated with the objects in the object history. If two object masks are substantially similar then the corresponding objects may be considered to be the same object. Conversely, if two object masks are substantially dissimilar then the corresponding objects may be considered to be different objects.

At block 508 a determination may be made as to whether an object in the object history also appears in the new object results. If an object in the object history does appear in the new object results (e.g., the object mask substantially matches an object mask in the new object results) then that object's confidence value may be increased (block 510). If, however, an object in the object history does appear in the new object results (e.g., the object, mask does not substantially match an object mask in the new object results) then that object's confidence value may be decreased (block 512). If an objects confidence value becomes too low as a result (e.g., if the object's confidence value falls below a minimum confidence value at block 512) then the corresponding object may be removed from the object, history at block 514 (e.g., the corresponding object mask may be deleted from the object history).

Process 500 may continue at block 516 with a determination of whether additional objects exist in the object history that have yet to be compared to the new object results. If addition objects remain then process 500 may loop back to block 508 and blocks 508-514 may be undertaken for another object in the object history. Process 500 may continue looping through blocks 508-516 until all the objects in the object history have been compared to the new object, results obtained from block 506.

At block 518 a determination may be made of whether any objects in the new object results do not appear in the object history, if the outcome of block 518 is negative (i.e., the new object results do not contain objects that are not already in the object history) then process 500 may loop back to block 506 where image segmentation may be performed on a next pre-capture image. If, however, the outcome of block 518 is positive (i.e., the new object results contain one or more objects that are not already in the object history) then process 500 may continue to block 320 where initial confidence values may be assigned to any new objects and the new objects may be added to the object history. Process 500 may then loop back to block 506 where image segmentation may be performed on a next pre-capture image. Process 500 may continue in this manner until it is determined that a shutter mechanism has been activated (block 208 of process 200).

Returning to discussion of FIG. 2, upon a determination that a shutter mechanism has been activated at block 208, process 200 may continue at block 210 with the capture and storage of the image and corresponding object masks. For instance, in response to the engagement or activation of a shutter mechanism of imaging device 102, image processing module 108 may capture an image and store that image in database 116. Further, image segmentation module 110 may store object results, such as object masks obtained from an object history (process 500), in database 116 in association with the stored image.

At block 212, object recognition and/or facial recognition may be performed on the captured image using the object masks and the recognized objects may be labeled. In various implementations, image tagging module 112 may employ known object and/or facial recognition techniques referred to previously to recognize and label objects appearing in the captured image using, at least in part, the object masks stored at block 210. At block 214 the captured image may then be automatically tagged using the object recognition and/or facial recognition results and the resulting image tags may be stored as metadata in database 116.

As a result of process 200, a captured image may be subjected to further processing based on the associated metadata. For example, during subsequent viewing of the captured images, a user may search for images or videos based on the image tags. The user may also select any object or person in an image and, based on object masks associated with the image, the system may determine which object or person has been selected. The label of the object or person may then be used to either provide information to the user or to search for related images or videos that also include the particular object or person in them.

### Interactive Focus Control

In various implementations, an imaging device in accordance with the present disclosure may use object information to provide interactive control of an imaging device's focusing mechanism. For example, based on the pre-capture image segmentation results, the imaging device is aware of the segmented objects in a scene and knows which objects are in the device's focus area. The imaging device may then give visual feedback to a user as to which object the device is focusing on. In various implementations, the image provided on the device's display or viewfinder may be displayed in a manner that highlights or otherwise indicates the object in focus. For example, the object in focus may be rendered sharp and the other objects and background appearing in the viewfinder and/or focus area may be blurred. In this way, the user may determine whether their imaging device is focusing on the object he/she intends it to. If the camera is focusing on the wrong object, the user ma correct it interactively by selecting another object on the viewfinder using, for example, touch screen control, and the imaging device may be caused to adjust its focus accordingly.

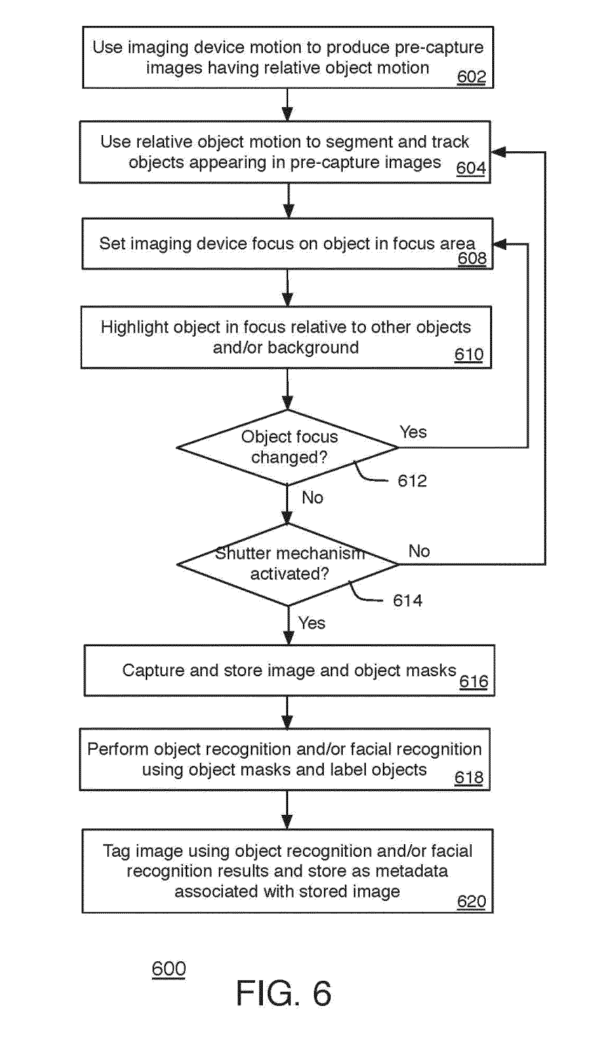

FIG. 6 illustrates a flow diagram of an example process 600 for interactive focus control according to various implementations of the present disclosure. Process 600 may include one or more operations, functions or actions as illustrated by one or more of blocks 602, 604, 608, 610, 612, 614, 616. 618 and 620 of FIG. 6. By way of non-limiting example, process 600 will be described herein with reference to image processing module 108 of example system 100 of FIG. 1.

Process 600 may begin at block 602 where pre-capture images may be received. At block 604 relative motion between objects in the pre-capture images may be used to segment and track those objects. For example, pre-capture images 107 may be received by image processing module 108 at block 602, and module 108 may employ image segmentation module 110 to undertake block 604 as described previously with respect to block 204 of process 200.

At block 608. the imaging device's focus may be set on an object in the device's focus area. In various implementations, focus control module 114 may use object information such as object masks obtained from either image segmentation module 110 or database 116 to set imaging device 102's focus mechanism on a particular segmented object appearing in a focus region (not shown) of device 102. In various implementations, an imaging device may select a most appropriate object to focus on from among the objects appearing in the device's focus area. For example, if objects corresponding to a person as well as an automobile are both within the focus area, the imaging device may focus on the person as the most likely appropriate object.

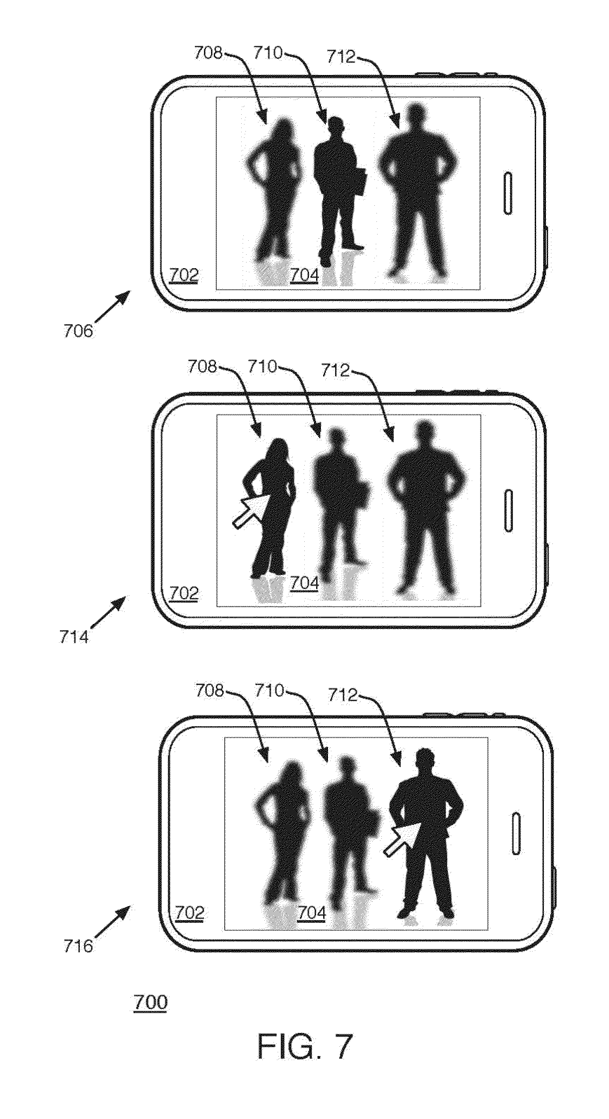

In various implementations, an imaging device viewfinder may display the latest pre-capture image of a scene along with an indication of which object in the scene is currently being focused upon. For instance, FIG. 7 illustrates an example scheme 700 for interactive focus control in accordance with the present disclosure. In scheme 700, an imaging device 702, in this example a camera equipped mobile communications device (e.g., a smart phone), includes a touch screen viewfinder display 704. In this example, at an initial instance 706, corresponding to block 608 of process 600, the scene shown on display 704 includes three objects 708, 710 and 712 corresponding to three different people.

For example, at block 608, imaging device 702 may automatically set its focusing mechanism to focus on object 710. Then, at block 610, the imaging device may highlight or otherwise distinguish the object in focus relative to other objects and/or background appealing in the viewfinder display. For example, as shown in FIG. 7 at instance 706, object 710 may be sharply displayed by imaging device 702 while objects 708 and 712 may be blurred. Of course, other schemes may be employed to highlight the focus object and the foregoing is just one non-limiting example. For instance, in various implementations, the object being focused on may have a representation of the corresponding object mask superimposed over the image where the object mask representation is depicted in a colored or bright outline and so forth.

At block 612 a determination may be made as to whether the imaging device's object focus has been changed. For example, in various implementations, a user of the imaging device may determine that they prefer another object to be the focus object rather than the object automatically selected by the imaging device at block 608. For instance, in accordance with the present disclosure, subsequent to the imaging device automatically selecting an object for focus at block 608, an imaging device may continue obtaining new pre-capture images until the device's shutter mechanism is engaged. Hence, segmentation and tracking (block 604) may be continually undertaken with respect to the newly obtained pre-capture images, while the object in focus is also tracked so that a user may, at block 612, interactively select a different object to focus on at any time.

When it is determined that the object focus has changed at block 612, process 600 may loop back to block 608. For example, as shown in FIG. 7, at a second instance 714, a user may interactively select a different object (in this example, object 708) for focus at block 612. In some implementations, the user may select a different object for focus using a cursor (as shown) or a finger touch or other GUI feature. After selecting a different object for focusing, the imaging device may then reset the imaging device focus to the selected object (block 608) and may highlight that object relative to the other objects at block 610. For example, at instance 714, object 708 has been displayed as sharp while objects 710 and 712 are blurred. Process 600 may continue to loop through blocks 608-612 as long as the user continue to select different objects for focus but has yet to engage the device's shutter mechanism. For example, at a third instance 716, the user may interactively select yet another object (in this example, object 712) for focus at block 612, and, at a corresponding iteration of block 610, object 712 may be displayed as sharp while objects 708 and 710 are displayed as blurred, and so forth.

Process 600 may then continue to block 614 where a determination may be made as to whether the imaging device's shutter mechanism has been activated. If the imaging device's shutter mechanism has yet to be activated, process 600 may loop back through blocks 604-612 as described above. if on the other hand, the imaging device's shutter mechanism has been activated, then process 600 may proceed to block 616 (capture and store image and object masks), block 618 (perform object recognition and/or facial recognition using object masks and label objects), and block 620 (tag image using object recognition and/or facial recognition results and store as metadata associated with stored image) as described above with respect to the corresponding portions of process 200, namely blocks 210, 212 and 214, respectively.

While implementation of example processes 200, 500 and 600, as illustrated in FIGS. 2, 5 and 6, may include the undertaking of all blocks shown in the order illustrated, the present disclosure is not limited in this regard and, in various examples, implementation of processes 200, 500 and 600 may include the undertaking only a subset of the blocks shown and/or in a different order than illustrated.

In addition, any one or more of the blocks of FIGS. 2, 5 and 6 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 2, 5 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

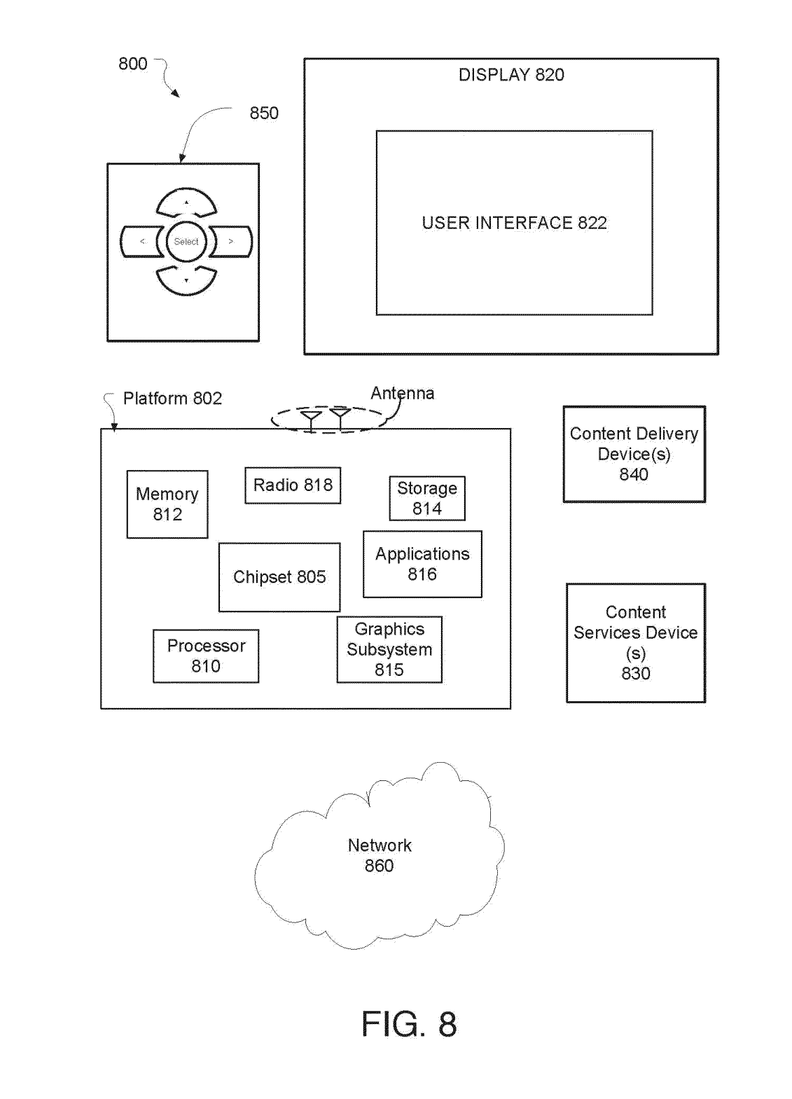

FIG. 8 illustrates an example system 800 in accordance with the present disclosure. In various implementations, system 800 may be a media system although system 800 is not limited to this context. For example, system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (NED), messaging device, data communication device, cameras (e.g. point-and-shoot cameras, super-zoom cameras, digital single-lens reflex (DSLR) cameras) and so forth.

In various implementations, system 800 includes a platform 802 coupled to a display 820. Platform 802 may receive content from a content device such as content services device(s) 830 or content delivery device(s) 840 or other similar content sources. A navigation controller 850 including one or more navigation features may be used to interact with, for example, platform 802 and/or display 820. Each of these components is described in greater detail below.

In various implementations, platform 802 may include any combination of a chipset 805, processor 810, memory 812, storage 814, graphics subsystem 815, applications 816 a or radio 818. Chipset 8115 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor 810 may be implemented as a Complex Instruction Set Computer (CISC) or Reduced Instruction Set Computer (RISC) processors, x86 instruction set compatible processors, multi-core, or any other microprocessor or central processing unit (CPU). various implementations, processor 810 may be dual-core processor(s), dual-core mobile processor(s), and so forth.

Memory 812 may be implemented as a volatile memory device such as, but not limited to, a Random Access Memory (RAM), Dynamic Random Access Memory (DRAM), or Static AM (SRAM).

Storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM, and/or a network accessible storage device. In various implementations, storage 814 may include technology to increase the storage performance enhanced protection for valuable digital media when multiple hard drives are included, for example.

Graphics subsystem 815 may perform processing of images such as still or video for display. Graphics subsystem 815 may be a graphics processing unit (GPU) or a visual processing unit (VPU), for example. An analog or digital interface may be used to communicatively couple graphics subsystem 815 and display 820. For example, the interface may be any of a High-Definition Multimedia Interface, DisplayPort, wireless HDMI, and/or wireless HD compliant techniques. Graphics subsystem 815 may be integrated into processor 810 or chipset 805. In some implementations, graphics subsystem 815 may be a stand-alone card communicatively coupled, to chipset 805.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 818 may include one or more radios capable of transmitting and receiving signals using various suitable wireless communications techniques. Such techniques may involve communications across one or more wireless networks. Example wireless networks include (but are not Limited to) wireless local area networks (WLANs), wireless personal area networks (WPANs), wireless metropolitan area network (WMANs), cellular networks. and satellite networks. In communicating across such networks, radio 818 may operate in accordance with one or more applicable standards in any version.

In various implementations, display 820 may include any television type monitor or display. Display 820 may include, for example, a computer display screen, touch screen display, video monitor, television-like device, and/or a television. Display 820 may be digital and/or analog. In various implementations, display 820 may be a holographic display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display user interface 822 on display 820.

In various implementations, content services device(s) 830 may be hosted by any national, international and/or independent service and thus accessible to platform 802 via the Internet, for example. Content services device(s) 830 may be coupled to platform 802 and/or to display 820. Platform 802 and/or content services device(s) 830 may be coupled to a network 860 to communicate (e.g., send and/or receive) media information to and from network 860. Content delivery device(s) 840 also may be coupled to platform 802 and/or to display 820.

In various implementations, content services device(s) 830 may include a cable television box, personal computer, network, telephone, Internet enabled devices or appliance capable of delivering digital information and/or content, and any other similar device capable of unidirectionally or bidirectionally communicating content between content providers and platform 802 and/display 820, via network 860 or directly. It will be appreciated that content may be communicated un directionally and/or bidirectionally to and from any one of the components in system 800 and a content provider via network 860. Examples of content may include any media information including, for example, video, music, medical and gaming information and so forth.

Content services device(s) 830 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 802 may receive control signals from navigation controller 850 having one or more navigation features. The navigation features of controller 850 may be used to interact with user interface 822, for example. in embodiments, navigation controller 850 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 850 may be replicated on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In embodiments, controller 850 may not be a separate component but may be integrated into platform 802 and display 820. The present disclosure, however, is not limited to the elements or in the context shown or described herein.

In various implementations, drivers (not shown) may include technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 even when the platform is Warned “off.” In addition, chipset 805 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the present disclosure.

In various embodiments, system 800 may be implemented as a wireless system, a wired system, or a combination of both, or a non-networked system. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller- video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

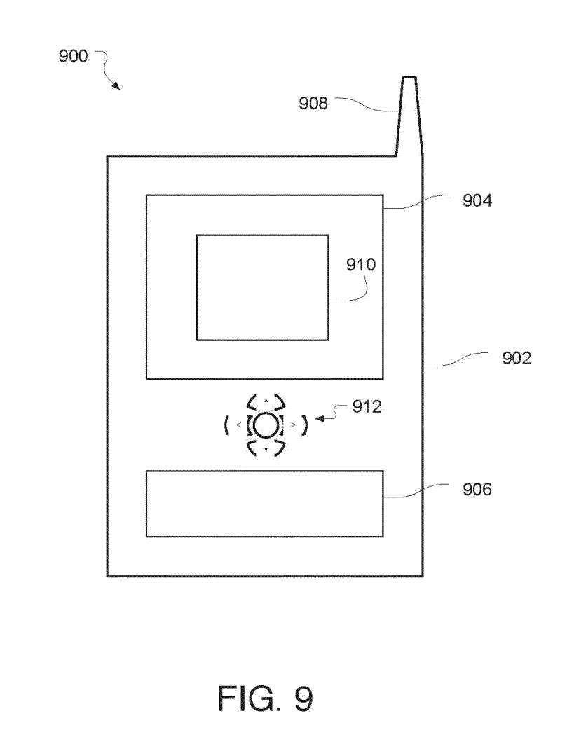

As described above, system 800 may be embodied in varying physical styles or form factors. FIG. 9 illustrates implementations of a small form factor device 900 in which system 800 may be embodied. In embodiments, for example, device 900 may be implemented as a mobile computing device with or without wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by Way of example, it may be appreciated that other embodiments may be implemented using other wireless mobile computing devices as well. The embodiments are not limited in this context.

As shown in FIG. 9, device 900 may include a housing 902, a display 904, an input/output (I/O) device 906, and an antenna 908. Device 900 also may include navigation features 912. Display 904 may include any suitable display unit for displaying information appropriate for a mobile computing device. I/O device 906 may include any suitable I/O device for entering information into a mobile computing device. Examples for I/O device 906 may include an alphanumeric keyboard, a numeric keypad, a touch pad, input keys, buttons, switches, rocker switches, microphones, speakers, voice recognition device and software, and so forth. Information also may be entered into device 900 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware. software modules, routines, subroutines, functions, methods, procedures, software interlaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-30. (canceled)

31. A computer-implemented method, comprising:
receiving a plurality of pre-capture images of a scene, the pre-capture images having been generated by an imaging device, the pre-capture images exhibiting object motion; and
performing image segmentation based on the object motion until a shutter mechanism of the imaging device is engaged to capture an image of the scene.

32. The method of claim 31, further comprising:
using results of the image segmentation to recognize and automatically tag objects appearing in the captured image.

33. The method of claim 32, wherein performing image segmentation comprises generating object masks corresponding to objects identified in the plurality of pre-capture images, and wherein using results of the image segmentation to recognize and automatically tag objects comprises:
storing the image and the object masks;
using the object masks to perform object recognition on the image; and
tagging objects appearing in the image using results of the object recognition.

34. The method of claim 33, wherein tagging objects appearing in the image comprises storing metadata associated with the image.

35. The method of claim 31, further comprising:
using results of the image segmentation to interactively control a focus mechanism of the imaging device.

36. The method of claim 35, wherein performing image segmentation includes segmenting and tracking a plurality of objects in the scene, and wherein using results of the image segmentation to interactively control the focus mechanism comprises:
setting the focus mechanism to focus on a first object of the plurality of objects; and
resetting the focus mechanism to focus on a second object of the plurality of objects.

37. The method of claim 36, wherein resetting the focus mechanism to focus on the second object comprises resetting the focus mechanism in response to user input.

38. The method of claim 36, wherein setting the focus mechanism to focus on the first object comprises highlighting the first object relative to other objects of the plurality of objects in the scene.

39. The method of claim 38, wherein highlighting the first object relative to the other objects comprises displaying the first object as sharp while displaying the other objects as blurred.

40. The method of claim 31, wherein performing image segmentation includes segmenting and tracking objects in the scene by:
performing image segmentation on at least a first image of the plurality of pre-capture images to generate a first plurality of object results;
storing the first plurality of object results;
performing image segmentation on a second image of the plurality of pre-capture images to generate a second plurality of object results; and
comparing the second plurality of object results to the first plurality of object results.

41. The method of claim 40, wherein the first plurality of object results comprises a first plurality of identified objects, wherein the second plurality of object results comprises a second plurality of identified objects, and wherein comparing the second plurality of object results to the first plurality of object results comprises:
increasing a confidence value of each object of the first plurality of identified objects that is included in the second plurality of identified objects; and
decreasing a confidence value of each object of the first plurality of identified objects that is not included in the second plurality of identified objects.

42. An article comprising a computer program product having stored therein instructions that, if executed, result in:
receiving a plurality of pre-capture images of a scene, the pre-capture images having been generated by an imaging device, the pre-capture images exhibiting object motion; and
performing image segmentation based on the object motion until a shutter mechanism of the imaging device is engaged to capture an image of the scene.

43. The article of claim 42, the computer program product having stored therein further instructions that, if executed, result in:
using results of the image segmentation to recognize and automatically tag objects appearing in the captured image.

44. The article of claim 42, the computer program product having stored therein further instructions that, if executed, result in:
using results of the image segmentation to interactively control a focus mechanism of the imaging device.

45. The article of claim 44, wherein performing image segmentation includes segmenting and tracking a plurality of objects in the scene, and wherein using results of the image segmentation to interactively control the focus mechanism comprises:
setting the focus mechanism to focus on a first object of the plurality of objects; and
resetting the focus mechanism to focus on a second object of the plurality of objects.

46. A device, comprising:
a processor configured to:
receive data corresponding to a plurality of pre-capture images of a scene, the pre-capture images having been generated by an imaging device, the pre-capture images exhibiting object motion; and
perform image segmentation based on the object motion until a shutter mechanism of the imaging device is engaged to capture an image of the scene.

47. The device of claim 46, wherein the processor is configured to:
use results of the image segmentation to recognize and automatically tag objects appearing in the captured image.

48. The device of claim 46, wherein the processor is configured to:
use results of the image segmentation to interactively control a focus mechanism of the imaging device.

49. The device of claim 48, wherein performing image segmentation includes segmenting and tracking a plurality of objects in the scene, and wherein using results of the image segmentation to interactively control the focus mechanism comprises:
setting the focus mechanism to focus on a first object of the plurality of objects; and
resetting the focus mechanism to focus on a second object of the plurality of objects.

50. A system comprising:
an imaging device to obtain a plurality of pre-capture images of a scene, the pre-capture images exhibiting object motion; and
an image processing module to receive the plurality of pre-capture images, and to perform image segmentation based on the object motion until a shutter mechanism of the imaging device is engaged to capture an image of the scene.

51. The system of claim 50, wherein the image processing module is configured to:
use results of the image segmentation to recognize and automatically tag objects appearing in the captured image.

52. The system of claim 50, wherein the image processing module is configured to:
use results of the image segmentation to interactively control a focus mechanism of the imaging device.

53. The system of claim 52, wherein performing image segmentation includes segmenting and tracking a plurality of objects in the scene, and wherein using results of the image segmentation to interactively control the focus mechanism comprises:
setting the focus mechanism to focus on a first object of the plurality of objects; and
resetting the focus mechanism to focus on a second object of the plurality of objects.
